(19) United States
(12) Patent Application Publication
(10) Pub. No.: US 2012/0170106 A1
(43) Pub. Date: Jul. 5, 2012

(54) ELECTRONIC PAPER DISPLAY DEVICE AND METHOD OF MANUFACTURING THE SAME

(75) Inventors: Sang Moon LEE, Seoul (KR); Sang Jin Kim, Suwon (KR); Jeong Bok Kwak, Suwon (KR); Young Woo Lee, Suwon (KR)

(73) Assignee: SAMSUNG ELECTRO-MECHANICS CO., LTD.

(21) Appl. No.: 13/231,373

(22) Filed: Sep. 13, 2011

(30) Foreign Application Priority Data
Dec. 30, 2010 (KR) 10-2010-0139021

(51) Int. Cl. G02F 1/167; H01J 9/24

(52) U.S. Cl. 359/296; 445/24

(57) ABSTRACT

There are provided an electronic paper display device and a method of manufacturing the same. The electronic paper display device includes first and second substrates disposed to be opposite to each other, and having a predetermined interval therebetween, a plurality of first barrier ribs formed between the first and second substrates to be spaced apart from each other, a plurality of second barrier ribs formed between the first and second substrates, disposed on the plurality of first barrier ribs, and intersecting with the plurality of first barrier ribs and electronic paper display elements disposed in cell spaces formed by the first and second barrier ribs. Therefore, the barrier ribs may be easily formed, a process thereof may be simply performed, and various patterns may be formed.

### CROSS-REFERENCE TO RELATED APPLICATIONS

This application claims the priority of Korean Patent Application No.10-2010-0139021 filed on Dec. 30, 2010, in the Korean Intellectual Property Office, the disclosure of which is incorporated herein by reference.

### BACKGROUND OF THE INVENTION

1. Field of the Invention

The present invention relates to an electronic paper display device in which a barrier rib structure may be easily manufactured, whereby a process thereof may be easily performed, and a method of manufacturing the same.

2. Description of the Related Art

In accordance with the recent development of portable information terminals, an information communications network, or the like, a demand for the development of a device having excellent portability and easy handling characteristics has increased. As a display device satisfying the demand therefor, an “electronic paper display device” has been prominent.

The “electronic paper display device” may have the flexibility to provide excellent portability and easy handling characteristics, may provide continuously clear image quality even after power is cut off, while being driven with a low voltage, and may provide a high resolution and a wide viewing angle.

As a technical method for implementing an “electronic paper display element”, there are mainly provided a method using a liquid crystal, an organic electroluminescence (EL) display, a reflective film reflection type display, an electrophoretic display, an electrochromic display, and the like.

In a recent method of using an electrophoretic capsule or a twist ball as an electronic paper display element configuring the electronic paper display device, there has been provided a method of coating a ball with liquid and attaching it to an elastomer matrix according to the related art.

However, this method had a difficulties in an oil injection process, and particularly, had difficulties in the process because it requires a dam structure in order to secure an addition injection path at the time of the injection of the oil.

### SUMMARY OF THE INVENTION

An aspect of the present invention provides an electronic paper display device in which a barrier rib structure may be easily manufactured, whereby a process of manufacturing the electronic paper display device may be easily performed, and a method of manufacturing the same.

According to an aspect of the present invention, there is provided an electronic paper display device including: first and second substrates disposed to be opposite to each other, and having a predetermined interval therebetween; a plurality of first barrier ribs formed between the first and second substrates to be spaced apart from each other; a plurality of second barrier ribs formed between the first and second substrates, disposed on the plurality of first barrier ribs, and intersecting with the plurality of first barrier ribs; and electronic paper display elements disposed in cell spaces formed by the first and second barrier ribs.

Each of the first and second barrier ribs may be formed in a transversal direction and a longitudinal direction of the first and second substrates.

The first barrier ribs may have a cross shape.

The first and second barrier ribs may be formed of a dry film resist.

The first and second barrier ribs may be formed on an upper portion of the first substrate.

Each of the first and second barrier ribs may have a height equal to half or more of a diameter of the electronic paper display elements.

The first barrier ribs may have a height of 10 to 30 μm, and the second barrier ribs may have a height of 40 to 70 μm.

The each of electronic paper display elements may be any one selected from a group consisting of a micro capsule, a twist ball, a transparent fluid, and a charged particle.

According to another aspect of the present invention, there is provided a method of manufacturing an electronic paper display device, the method including: preparing first and second substrates; forming first barrier ribs on an upper portion of the first substrate so as to be spaced apart from each other; forming second barrier ribs on the first barrier ribs so as to be spaced apart from each other and intersect with the first barrier ribs; and mounting electronic paper display elements in cells formed by the first and second barrier ribs and attaching the first and second substrates to each other.

The method may further include forming a fluid inlet in the first substrate or the second substrate, the fluid inlet having external fluid injected therethrough.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A through 1C are plan views for each operation of manufacturing an electronic paper display device according to a first exemplary embodiment of the present invention;

FIG. 2A is a cross-sectional view showing the electronic paper display device when viewed from the side of FIG. 1C;

FIG. 2B is a cross-sectional view showing the electronic paper display device when viewed from the front of FIG. 1C;

FIGS. 3A through 3C are plan views for each operation of manufacturing an electronic paper display device according to a second exemplary embodiment of the present invention;

FIG. 4A is a cross-sectional view showing the electronic paper display device when viewed from the side of FIG. 3C; and

FIG. 4B is a cross-sectional view showing the electronic paper display device when viewed from the front of FIG. 3C.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

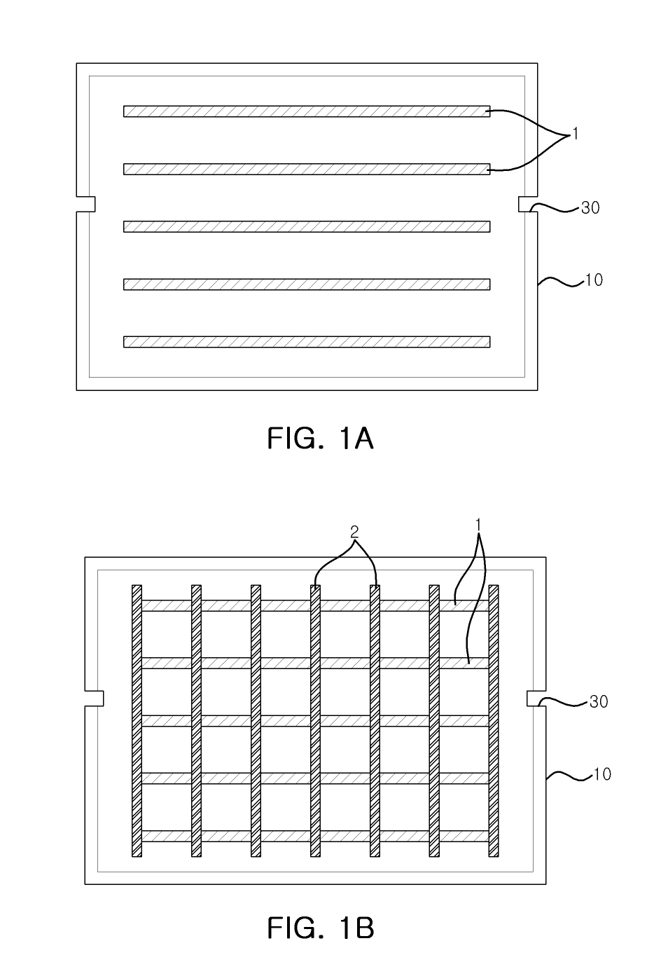

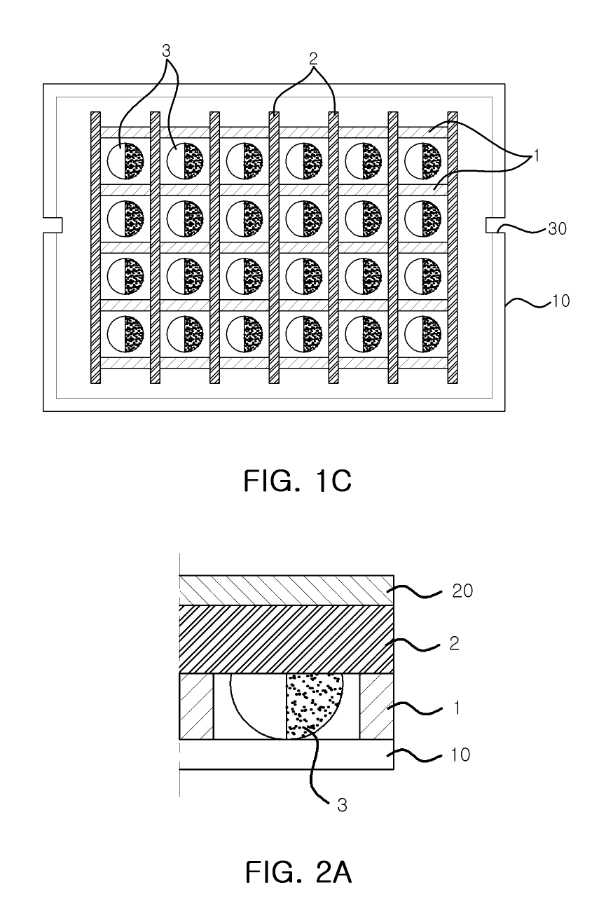

FIGS. 1A through 1C are plan views for each operation of manufacturing an electronic paper display device according to a first exemplary embodiment of the present invention.

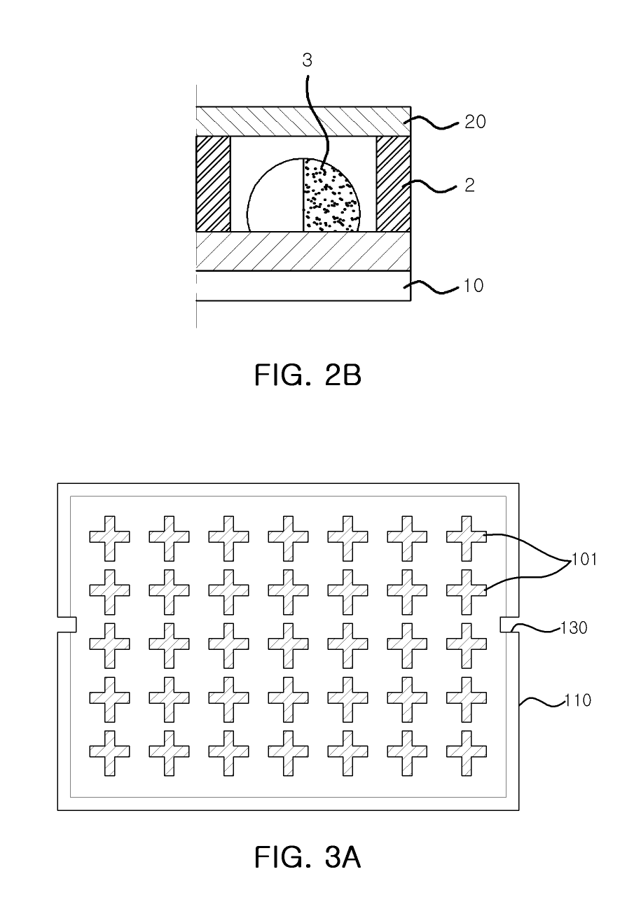

FIG. 2A is a cross-sectional view showing the electronic paper display device when viewed from the side of FIG. 1C; and FIG. 2B is a cross-sectional view showing the electronic paper display device when viewed from the front of FIG. 1C.

An electronic paper display device according to a first exemplary embodiment of the present invention includes first and second substrates 10 and 20 disposed to be opposite to each other, having a predetermined interval therebetween; a plurality of first barrier ribs 1 formed to be spaced apart from each other between the first and second substrates 10 and 20; a plurality of second barrier ribs 2 formed between the first and second substrates 10 and 20, disposed on the plurality of first barrier ribs 1, and intersecting with the plurality of first barrier ribs 1; and electronic paper display elements 3 disposed in cell spaces formed by the first and second barrier ribs 1 and 2.

According to the first exemplary embodiment of the present invention, each of the first and second substrates 10 and 20 may be a lower substrate and an upper substrate, and the first substrate 10 is not specifically limited but may be a semiconductor single crystal substrate such as, for example, a silicon (Si) substrate.

In addition, the first substrate 10 may have a first electrode (not shown) formed on a lower portion thereof.

The second substrate 20 may have a second electrode (not shown) formed on an upper portion thereof, the second electrode being made of a transparent material. The second substrate 20 is not specifically limited but may be configured to include, for example, glass, indium tin oxide and a touch screen panel (TSP).

The second substrate 20 is not specifically limited but may be made of a light transmitting material.

The plurality of first barrier ribs 1 may be formed to be spaced apart from each other between the first and second substrates 10 and 20, and the plurality of second barrier ribs 2 may be formed on the plurality of first barrier ribs 1 while intersecting therewith.

Each of the first and second barrier ribs 1 and 2 may be formed in a transverse direction and a longitudinal direction of the first and second substrates 10 and 20.

The plurality of first barrier ribs 1 may be formed such that they are spaced apart from each other in a transverse direction, that is, an X axis direction, of the first and second substrates 10 and 20 disposed to be opposite to each other.

The plurality of first barrier ribs 1 may be formed on the first barrier ribs 1 such that they are spaced apart from each other in a longitudinal direction, that is, a Y axis direction, of the first and second substrates 10 and 20.

Due to the disposition of the first and second barrier ribs 1 and 2 as described above, each of the electronic paper display elements 3 may be disposed in a cell space formed by the respective first and second barrier ribs 1 and 2 as shown in FIGS. 2A and 2B.

In addition, the first and second barrier ribs are disposed to intersect with each other to thereby generate an oil injection path between each of the first and second barrier ribs, whereby a dam structure for securing an additional injection path in order to inject oil according to the related art may not be required.

Therefore, an oil injection process which has been difficult in barrier rib structures according to the related art may be easily performed.

In addition, as a dam structure for injecting oil is not required, the oil injection process may be simplified and easily performed.

Furthermore, the first and second barrier ribs 1 and 2 are disposed to intersect with each other to form a space therebetween, whereby a flexible electronic paper display device may be implemented.

According to the first exemplary embodiment of the present invention, the first and second barrier ribs may be formed of a dry film resist.

According to the first exemplary embodiment of the present invention, a primary barrier rib may first be formed by using the dry film resist.

Then, the primary barrier rib may be subjected to drying and curing processes at a temperature of 150° C. for 30 minutes, whereby the strength of primary barrier rib may be enhanced.

Thereafter, the barrier rib may be subjected to imprint, lithography, and etching processes.

Developing in the lithography process may be performed by using a sodium carbonate (Na₂CO₃) diluted solution.

As described above, according to the first exemplary embodiment of the present invention, the barrier rib is formed through two processes, that is, the imprint and lithography processes, whereby the barrier rib may be easily manufactured.

According to the related art, a method of forming a structure having a predetermined height by applying a polymer to an upper portion of a first substrate, and forming a barrier rib or a pattern on the structure by using a physical process such as a laser process or a sandblast process with respect to the structure has been required.

On the other hand, according to an exemplary embodiment of the present invention, the dry film resist is used to form the barrier rib, whereby the barrier rib may be easily formed.

In addition, various patterns capable of constraining the electronic paper display elements may be formed at the time of forming of the barrier rib.

Meanwhile, the barrier rib may be formed in a simple pattern, whereby a fine pattern and space may be implemented.

A method of forming the first and second barrier ribs is not specifically limited. The first and second barrier ribs may be separately formed on an upper portion of the first substrate or the second substrate or be formed on an upper of the first substrate.

The heights of the first and second barrier ribs are not limited so long as they are sufficient to dispose the electronic paper display element within the cell formed by the first and second barrier ribs. For example, each of the first and second barrier ribs may have a height equal to half or more of a diameter of the electronic paper display element.

Particularly, the first barrier rib 1 may have a height of 10 to 30 μm, and the second barrier rib 2 may have a height of 40 to 70 μm.

The electronic paper display element 3 is not specifically limited, as long as it is used in the art, and may be any one selected from a group consisting of a micro capsule, a twist ball, a transparent fluid, and a charged particle.

The electronic paper display device according to the first exemplary embodiment of the present invention may further include a fluid inlet 30 formed in the first substrate or the second substrate, the fluid inlet 30 having external fluid injected therethrough.

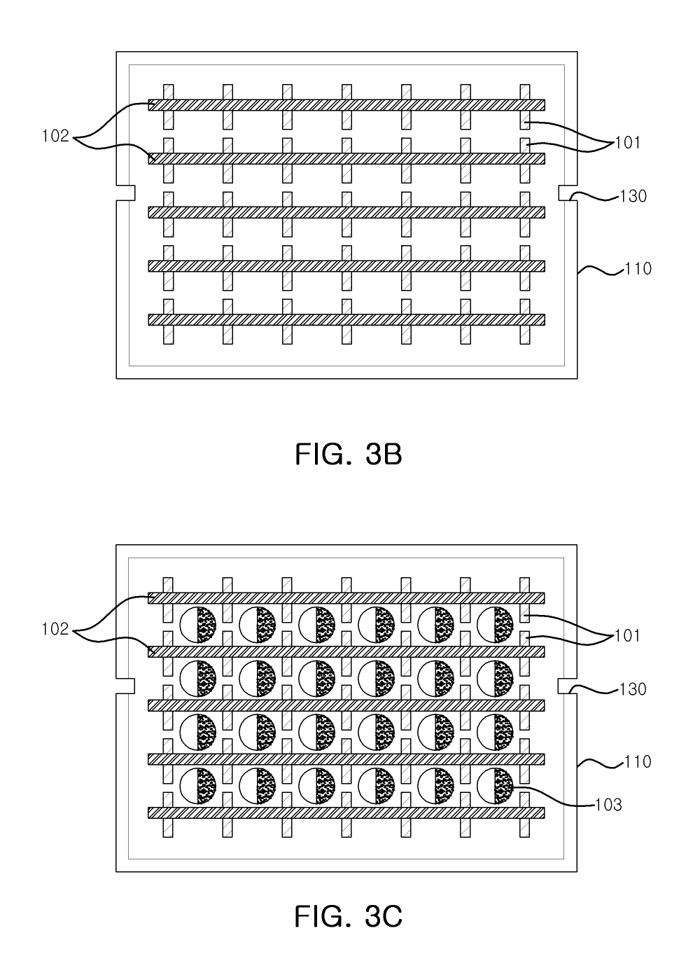

FIGS. 3A through 3C are plan views for each operation of manufacturing an electronic paper display device according to a second exemplary embodiment of the present invention.

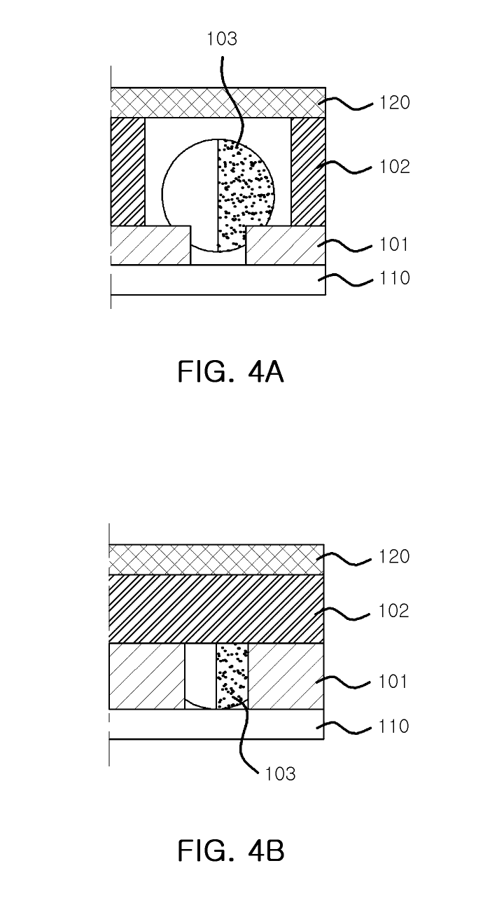

FIG. 4A is a cross-sectional view showing the electronic paper display device when viewed from the side of FIG. 3C; and FIG. 4B is a cross-sectional view showing the electronic paper display device when viewed from the front of FIG. 3C.

Referring to FIGS. 3A through 3C and FIGS. 4A and 4B, an electronic paper display device according to a second exemplary embodiment of the present invention is the same as the electronic paper display device according to the first exemplary embodiment of the present invention, except that first barrier ribs may have a plurality of cross shapes.

That is, the electronic paper display device according to the second exemplary embodiment of the present invention includes first and second substrates 110 and 120 disposed to be opposite to each other, having a predetermined space therebetween; a plurality of first barrier ribs 101 formed to be spaced apart from each other between the first and second substrates 110 and 120; a plurality of second barrier ribs 102 formed between the first and second substrates 110 and 120, disposed on the plurality of first barrier ribs 101, and intersecting with the plurality of first barrier ribs 101; and electronic paper display elements 103 disposed in cell spaces formed by the first and second barrier ribs 101 and 102.

In addition, similarly to the electronic paper display device according to the first exemplary embodiment of the present invention, the electronic paper display device according to the second exemplary embodiment of the present invention may further include a fluid inlet 130 formed in the first substrate 110 or the second substrate 120, the fluid inlet 130 having external fluid injected therethrough.

A method of manufacturing an electronic paper display device according to another exemplary embodiment of the present invention includes preparing first and second substrates; forming first barrier ribs on an upper portion of the first substrate so as to be spaced apart from each other; forming second barrier ribs on the first barrier ribs so as to be spaced apart from each other and intersect with the first barrier ribs; and mounting electronic paper display elements in cells formed by the first and second barrier ribs and attaching the first and second substrates to each other.

FIGS. 1A through 1C are plan views showing a method of manufacturing an electronic paper display device according to the first exemplary embodiment of the present invention in which the first barrier rib has a linear structure; and FIGS. 3A through 3C are plan views showing a method of manufacturing an electronic paper display device according to the second exemplary embodiment of the present invention in which the first barrier rib has a cross structure.

Hereinafter, a method of manufacturing an electronic paper display device will be described in detail with reference to FIGS. 1A through 1C and FIGS. 3A through 3C.

In the method of manufacturing an electronic paper display device according to an exemplary embodiment of the present invention, the first and second substrates are first prepared.

The first and second substrates are the same as those described in the electronic paper display device according to the first exemplary embodiment of the present invention.

Then, the first barrier ribs may be formed on an upper portion of the first substrate so as to be spaced apart from each other.

The first barrier ribs may be formed by various methods. For example, the first barrier ribs may be formed on an upper portion of the first substrate and be formed in plural so as to be spaced apart from each other.

A shape of the first barrier rib is not limited. According to the exemplary embodiment of the present invention, the barrier rib may be formed to have a linear shape in a transverse direction of the first and second substrates or be formed to have a cross shape.

After the first barrier ribs are formed, the second barrier ribs may be formed on the first barrier ribs so as to be spaced apart from each other and intersect with the first barrier ribs.

Referring to FIGS. 1A through 1C, the second barrier ribs 2 maybe formed on the first barrier ribs 1 in a longitudinal direction of the first and second substrates 10 and 20.

In addition, referring to FIGS. 3A through 3C, the second barrier ribs 102 may also be formed on the first barrier ribs 101, each having a cross shape.

As described above, the first and second barrier ribs are disposed to intersect with each other to thereby generate an oil injection path between each of the first and second barrier ribs, whereby a dam structure for securing an additional injection path in order to inject oil according to the related art may not be required.

Therefore, an oil injection process which has been difficult in barrier rib structures according to the related art may be easily performed.

In addition, as a dam structure for injecting oil is not required, the oil injection process may be simplified and easily performed

Furthermore, the first and second barrier ribs are disposed to intersect with each other to form a space therebetween, whereby a flexible electronic paper display device may be implemented.

According to the method of manufacturing an electronic paper display device according to the exemplary embodiment of the present invention, the first and second barrier ribs may be formed of a dry film resist.

According to the exemplary embodiment of the present invention, a primary barrier rib may be first formed by using the dry film resist.

Then, the primary barrier rib may be subjected to drying and curing processes at a temperature of 150° C. for 30 minutes, whereby the strength of primary barrier rib may be enhanced.

Thereafter, the barrier rib may be subjected to imprint, lithography, and etching processes.

Developing in the lithography process may be performed by using a sodium carbonate (Na₂CO₃) diluted solution.

As described above, according to the exemplary embodiment of the present invention, the barrier rib is formed through two processes, that is, the imprint and lithography processes, such that the barrier rib may be easily manufactured.

In addition, various patterns capable of constraining the electronic paper display element may be formed at the time of forming of the barrier rib.

The barrier rib may be formed in a simple pattern, whereby micro patterns and spaces may be implemented.

The heights of the first and second barrier ribs are not limited if they are sufficient to dispose the electronic paper display element within the cell formed by the first and second barrier ribs. For example, each of the first and second barrier ribs may have a height equal to half or more of a diameter of the electronic paper display element.

Particularly, the first barrier rib 1 may have a height of 10 to 30 μm, and the second barrier rib 2 may have a height of 40 to 70 μm.

Referring to FIGS. 1A through 1C and FIGS. 3A through 3C, the electronic paper display elements 3 or 103 are mounted in the cells formed the first barrier ribs 1 or 101 and the second barrier ribs 2 or 102 and the first substrate 10 or 110 and the second substrate 20 or 120 are attached to each other, whereby the electronic paper display device may be manufactured.

The electronic paper display element 3 or 103 is not specifically limited as long as it is used in the art but may be any one selected from a group consisting of a micro capsule, a twist ball, a transparent fluid, and a charged particle.

As described above, according to the exemplary embodiments of the present invention, the first and second barrier ribs are formed while intersecting with each other to thereby form an oil injection path, whereby the oil injection process may be simplified and easily performed.

In addition, the first and second barrier ribs may be made of a dry film resist and may be formed through imprint and lithography processes, whereby they may be easily manufactured.

In addition, various patterns capable of constraining the electronic paper display element may be formed at the time of forming of the barrier rib.

The barrier rib may be formed in a simple pattern, whereby a fine pattern and space may be implemented.

As set forth above, according to the exemplary embodiments of the present invention, the barrier rib structure may be manufactured through the lithography and imprint processes, thereby being easily manufactured, and the oil injection path is prepared through the formation of the barrier rib structure, whereby the process thereof could be easily performed.

In addition, various patterns capable of constraining the electronic paper display element may be formed, and the barrier rib structure may be formed in a simple pattern, whereby a fine line and space may be implemented and a flexible electronic paper display device may be implemented.

While the present invention has been shown and described in connection with the exemplary embodiments, it will be apparent to those in the art that modifications and variations can be made without departing from the spirit and scope of the invention as defined by the appended claims. Accordingly, various substitutions, modifications and alterations may be made within the scope of the present invention may be made by those skilled in the art without departing from the spirit of the prevent invention defined by the accompanying claims.

What is claimed is:

1. An electronic paper display device comprising:
first and second substrates disposed to be opposite to each other, and having a predetermined interval therebetween;
a plurality of first barrier ribs formed between the first and second substrates to be spaced apart from each other;
a plurality of second barrier ribs formed between the first and second substrates, disposed on the plurality of first barrier ribs, and intersecting with the plurality of first barrier ribs; and
electronic paper display elements disposed in cell spaces formed by the first and second barrier ribs.

2. The electronic paper display device of claim 1, wherein each of the first and second barrier ribs is formed in a transversal direction and a longitudinal direction of the first and second substrates.

3. The electronic paper display device of claim 1, wherein the first barrier ribs have a cross shape.

4. The electronic paper display device of claim 1, wherein the first and second barrier ribs are formed of a dry film resist.

5. The electronic paper display device of claim 1, wherein the first and second barrier ribs are formed on an upper portion of the first substrate.

6. The electronic paper display device of claim 1, wherein each of the first and second barrier ribs has a height equal to half or more of a diameter of the electronic paper display elements.

7. The electronic paper display device of claim 1, wherein the first barrier ribs have a height of 10 to 30 μm.

8. The electronic paper display device of claim 1, wherein the second barrier ribs have a height of 40 to 70 μm.

9. The electronic paper display device of claim 1, wherein each of the electronic paper display elements is any one selected from a group consisting of a micro capsule, a twist ball, a transparent fluid, and a charged particle.

10. A method of manufacturing an electronic paper display device, the method comprising:
preparing first and second substrates;
forming first barrier ribs on an upper portion of the first substrate so as to be spaced apart from each other;
forming second barrier ribs on the first barrier ribs so as to be spaced apart from each other and intersect with the first barrier ribs; and
mounting electronic paper display elements in cells formed by the first and second barrier ribs and attaching the first and second substrates to each other.

11. The method of claim 10, further comprising forming a fluid inlet in the first substrate or the second substrate, the fluid inlet having external fluid injected therethrough.

12. The method of claim 10, wherein each of the first and second barrier ribs is formed in a transversal direction and a longitudinal direction of the first and second substrates.

13. The method of claim 10, wherein the first barrier ribs have a cross shape.

14. The method of claim 10, wherein the first and second barrier ribs are formed of a dry film resist.

15. The method of claim 10, wherein each of the first and second barrier ribs has a height equal to half or more of a diameter of the electronic paper display elements.

16. The method of claim 10, wherein the first barrier ribs have a height of 10 to 30 μm.

17. The method of claim 10, wherein the second barrier ribs have a height of 40 to 70 μm.
